(19) United States
(12) Patent Application Publication
(10) Pub. No.: US 2013/0107662 A1
(43) Pub. Date: May 2, 2013

(54) PHOTOACOUSTIC MICROSCOPY (PAM) SYSTEMS AND RELATED METHODS FOR OBSERVING OBJECTS

(71) Applicants: Meng-Lin Li, Hsinchu City (TW); Po-Hsun Wang, Kaohsiung City (TW)

(72) Inventors: Meng-Lin Li, Hsinchu City (TW); Po-Hsun Wang, Kaohsiung City (TW)

(21) Appl. No.: 13/457,468

(22) Filed: Apr. 26, 2012

Related U.S. Application Data
(60) Provisional application No. 61/551,604, filed on Oct. 26, 2011.

(51) Int. Cl. G03B 42/06

(52) U.S. Cl. 367/7

(57) ABSTRACT

Embodiments of the invention provide a photoacoustic microscopy (PAM) system for observing an object. The PAM system includes an optical pickup head, an ultrasonic transducer, and an image generation unit. The optical pickup head emits a laser beam to the object, generates a servo signal based on a reflective light beam received from the object, and positions a focus of the laser beam onto the object based on the servo signal. The ultrasonic transducer detects laser-induced ultrasonic waves leaving the object to generate a PAM imaging signal. The image generation unit generates a PAM image of the object based on the PAM imaging signal.

### CROSS REFERENCE TO RELATED APPLICATIONS

This application claims the benefit of U.S. provisional application No. 61/551,604, filed on Oct. 26, 2011 and incorporated herein by reference.

### BACKGROUND

1. Technical Field

The invention relates generally to photoacoustic microscopy (PAM), and more particularly, to PAM systems using optical pickup heads as light sources.

2. Related Art

Photoacoustic microscopy (PAM) is an imaging technology of broad potential applications. For example, it has been proven that PAM can be used to observe biological structures, such as capillaries, label-freely and even in vivo.

Despite its advantages, PAM has not become a popular technology yet. An important reason behind this is that most conventional PAM systems use lasers that are not only bulky but also costly. Such lasers make the conventional PAM systems cumbersome, inconvenient to use, and less affordable.

### SUMMARY

Embodiments of the invention provide a photoacoustic microscopy (PAM) system for observing an object. The PAM system includes an optical pickup head, an ultrasonic transducer, and an image generation unit. The optical pickup head emits a laser beam to the object, generates a servo signal based on a reflective light beam received from the object, and positions a focus of the laser beam onto the object based on the servo signal. The ultrasonic transducer detects laser-induced ultrasonic waves leaving the object to generate a PAM imaging signal. The image generation unit generates a PAM image of the object based on the PAM imaging signal.

Embodiments of the invention further provide a method of observing an object. The method includes: using an optical pickup head to emit a laser beam to the object; detecting laser-induced ultrasonic waves leaving the object to generate a PAM imaging signal; and generating a PAM image of the object based on the PAM imaging signal.

Other features of the present invention will be apparent from the accompanying drawings and from the detailed description which follows.

### BRIEF DESCRIPTION OF THE DRAWINGS

The invention is fully illustrated by the subsequent detailed description and the accompanying drawings, in which like references indicate similar elements.

FIG. 1 shows a simplified block diagram of a PAM system according to an embodiment of the invention.

FIG. 2 shows a simplified block diagram of an optical pickup head of the feedback-controlled laser of FIG. 1.

FIG. 3 and FIG. 4 show two schematic diagrams of the feedback-controlled laser of FIG. 1.

FIG. 5 shows a schematic diagram of a micro-electromechanical lens set that can be included in the feedback-controlled laser of FIG. 1.

FIG. 6 shows a schematic diagram of a confocal microscopy (CM) component set that can be included in the PAM system of FIG. 1.

FIG. 7 shows a simplified block diagram of a modified optical pickup head of the feedback-controlled laser of FIG. 1.

### DETAILED DESCRIPTION

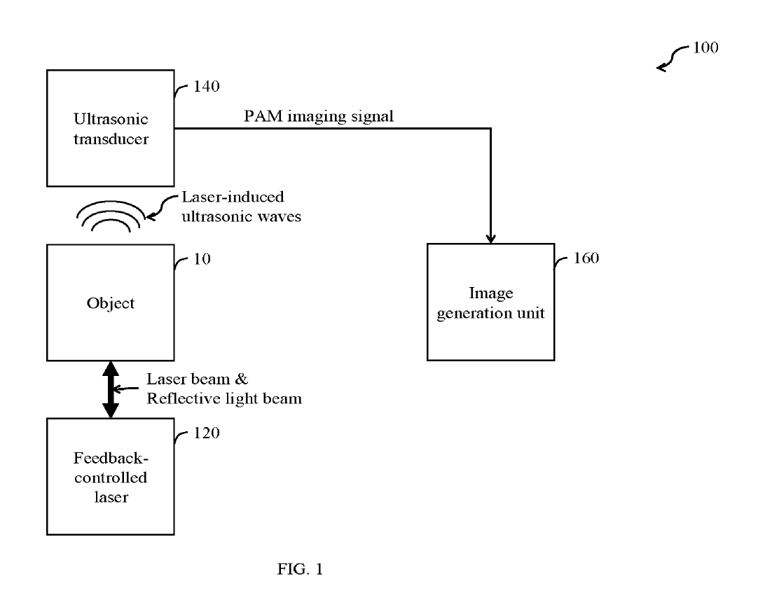

FIG. 1 shows a simplified block diagram of a PAM system according to an embodiment of the invention. This PAM system 100 can be used to observe an object 10, which is not a part of the PAM system 100. The PAM system 100 includes a feedback-controlled laser 120, an ultrasonic transducer 140, and an image generation unit 160.

As mentioned, FIG. 1 is only a simplified block diagram of the PAM system 100. Although the feedback-controlled laser 120 and the ultrasonic transducer 140 are depicted on two different sides of the object 10, they can also be arranged on the same side of the object 10. If these two components are on the same side of the object 10, the PAM system 100 may be able to scan images of the object 10 in vivo. The feedback-controlled laser 120 can be independent from the ultrasonic transducer 140, or be integrated with or even embedded within the ultrasonic transducer 140.

In addition to the components depicted in FIG. 1, the PAM system 100 can further include some mechanisms that enable the PAM system 100 to scan images of the object 10 by moving the object 10, the feedback-controlled laser 120, or the ultrasonic transducer 140, or a combination thereof. Furthermore, the PAM system 100 can further include a control unit that coordinates the operations of the PAM system 100's components. Moreover, the object 10 can be fixed on an optical disc such as a compact disc (CD), a digital versatile disc (DVD), or a blue-ray disc (BD).

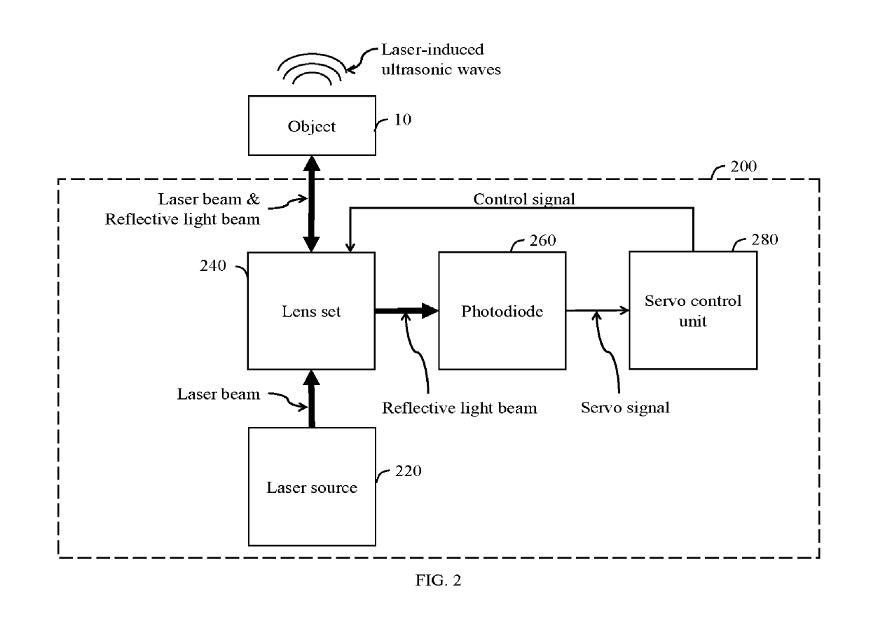

The feedback-controlled laser 120 can include one or more optical pickup heads. Each of the included optical pickup head may resemble or be identical to an optical pickup head used in an optical disc drive, such as a CD drive, a DVD drive, or a BD drive. FIG. 2 shows a simplified block diagram of an optical pickup head of the feedback-controlled laser 120 of FIG. 1. The optical pickup head 200 includes a laser source 220, a lens set 240, a photodiode 260, and a servo control unit 280. For example, the laser source 220 can include an infrared laser diode with a wavelength of (or close to) 780 nm, a red laser diode with a wavelength of (or close to) 650 nm, or a blue laser diode with a wavelength of (or close to) 405 nm, or a combination thereof. Actually, the wavelength used can be adjusted according to the object being observed, and not limited in the wavelengths mentioned above. If the laser source 220 includes multiple laser diodes with different wavelengths, the PAM system 100 can be used to observe the object 10's constituents of different absorption wavelengths.

Because the feedback-controlled laser 120 uses optical pickup head(s) as light source(s) and optical pickup head(s) are small and inexpensive, the PAM system 100 is more compact and more affordable than conventional PAM systems. Furthermore, the feedback control loop of the optical pickup head(s), which will be introduced later, makes aligning easier for the PAM system 100.

The lens set 240 directs the laser beam from the laser source 220 to the object 10, and in the meantime directs the light beam reflected back from the object 10 to the photodiode 260. Like the lens set in an optical disc drive's optical pickup head, the lens set 240 can include a diffraction grating, a beam splitter, a collimator lens, and an objective lens. The laser beam emitted by the laser source 220 will pass through the diffraction grating, the beam splitter, the collimator lens, and the objective lens successively, and then reach the object 10. The reflected light beam that leaves the object 10 will pass through the objective lens, the collimator lens, and the beam splitter successively, and then reach the photodiode 260. The collimator lens and the objective lens provide an optical path between the object 10 and the beam splitter. The beam splitter allows the laser beam and the reflective light beam to share the optical path by passing through it in two opposite directions. The lens set 240 can further include an actuator, such as a voice coil motor, that controls the position of the laser beam's focus by moving the object lens. As will be explained below, the actuator can be controlled by the servo control unit 280.

The lens set 240, the photodiode 260, and the servo control unit 280 constitute a feedback control loop of the optical pickup head 200. Specifically, the photodiode 260 detects the reflective light beam and generates a servo signal accordingly. The servo signal indicates whether the position of the laser beam's focus needs to be changed. Based on the servo signal, the servo control unit 280 generates a control signal, e.g. to control the aforementioned actuator of the lens set 240 to move the object lens. For example, the servo signal can include a focus error (FE) signal generated with the astigmatism method, which is well-known in the optical disc drive industry.

With the feedback-controlled laser 120, the ultrasonic transducer 140, and the image generation unit 160, the PAM system 100 can realize a PAM function. Specifically, the laser beam emitted by each optical pickup head 200 of the feedback-controlled laser 120 not only causes the object 10 to reflect a light beam backward, but also induces the object 10 to generate ultrasonic waves. The laser-induced ultrasonic waves are strong when the laser beam focuses on a region of the object 10 that absorbs a lot of the light energy; the laser-induced ultrasonic waves are weak or undetectable when the laser beam focuses on a region of the object 10 that absorbs only a little or none of the light energy. The ultrasonic transducer 140 then detects the laser-induced ultrasonic waves and accordingly generates a PAM imaging signal. In doing so, the ultrasonic transducer 140's focus (if there is one) and the laser beam's focus can overlap on a region of the object 10. Thereafter, the image generation unit 160, which can be a computer, generates a PAM image (or multiple PAM images) of the object 10 based on the PAM imaging signal.

If the feedback-controlled laser 120 includes only one optical pickup head 200, the PAM system 100's PAM function can involve the following iterative steps. First, the PAM system 100 locates (or relocates) the focus of the optical pickup head 200 to a region of the object 10. Then, the optical pickup head 200 emit a pulse of laser beam to the region to induce ultrasonic waves. Next, the ultrasonic transducer 140 detects the laser-induced ultrasonic waves coming out from the object and generates the PAM imaging signal accordingly. The PAM system 100 repeats these steps for a plurality of regions of the object 10. Based on the resultant PAM imaging signal, the image generation unit 160 can generate PAM image(s) of the object 10.

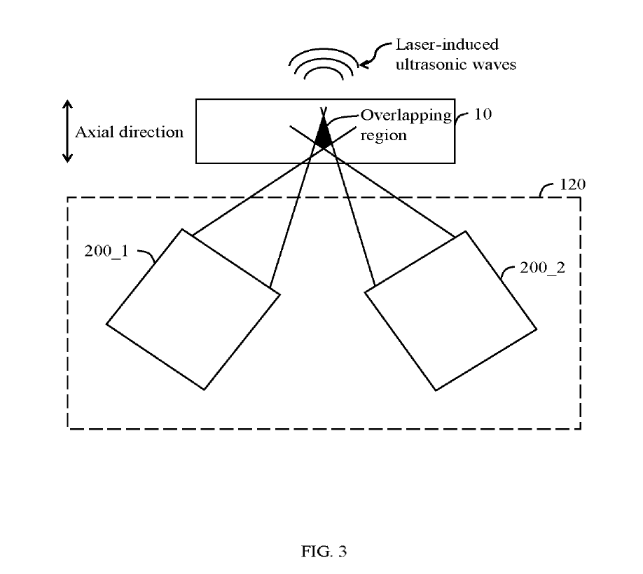

The PAM system 100 can have an enhanced resolution if the feedback-controlled laser 120 includes multiple optical pickup heads 200 at different positions or a single optical pickup head 200 that can be moved to different positions, e.g. by a rotator. FIG. 3 shows a schematic diagram of the feedback-controlled laser 120 that includes two optical pickup heads 200 of FIG. 2. The optical pickup head 200_1 and the optical pickup head 200_2 are aligned so that the focused regions of the laser beams generated by the optical pickup heads 200_1 and 200_2 share an overlapping region on the object 10. Because the overlapping region can be relatively small, the arrangement shown in FIG. 3 can increase the PAM system 100's resolution, especially along the axial direction indicated in FIG. 3.

With the feedback-controlled laser 120 shown in FIG. 3, the PAM system 100's PAM function can involve the following iterative steps. First, the PAM system 100 locates (or relocates) the overlapping region of the two optical pickup heads 200_1 and 200_2 to a region of the object 10. Next, the optical pickup head 200_1 emits a pulse of laser beam to induce ultrasonic waves from the object 10, which are detected by the ultrasonic transducer 140. Similarly, the optical pickup head 200_2 also emits a pulse of laser beam to induce ultrasonic waves from the object 10, which are also detected by the ultrasonic transducer 140. The two optical pickup heads 200_1 and 200_2 can emit the two pulses simultaneously or at different times. Based on the laser-induced ultrasonic waves coming out from the object 10, the ultrasonic transducer 140 generates the PAM imaging signal accordingly. The PAM system 100 repeats these steps for a plurality of regions of the object 10, specifically, by relocating the overlapping region of the laser beams to the plurality of regions of the object 10 successively. Based on the resultant PAM imaging signal, the image generation unit 160 can generate PAM image(s) of the object 10 with an enhanced resolution.

For example, the PAM imaging signal may have a first time domain section corresponding to the laser-induced ultrasonic wave that comes out from a first region of the object 10 and is induced by a pulse generated by the optical pickup head 200_1. In addition, the PAM imaging single may have a second time domain section corresponding to the laser-induced ultrasonic wave that comes out from a second region of the object 10 and is induced by a pulse generated by the optical pickup head 200_2. The first and the second region of the object 10 may partially overlap with each other. By processing, combining, or reconstructing, the first and second time domain sections of the PAM imaging signal, the image generation unit 160 may enhance the axial resolution to the overlapping region on the object 10. Please note that the concept mentioned in this and the previous paragraphs can be expanded to an extent that the feedback-controlled laser 120 includes M well-aligned optical pickup heads 200_{—1}˜200_M, where M is an integer larger than two.

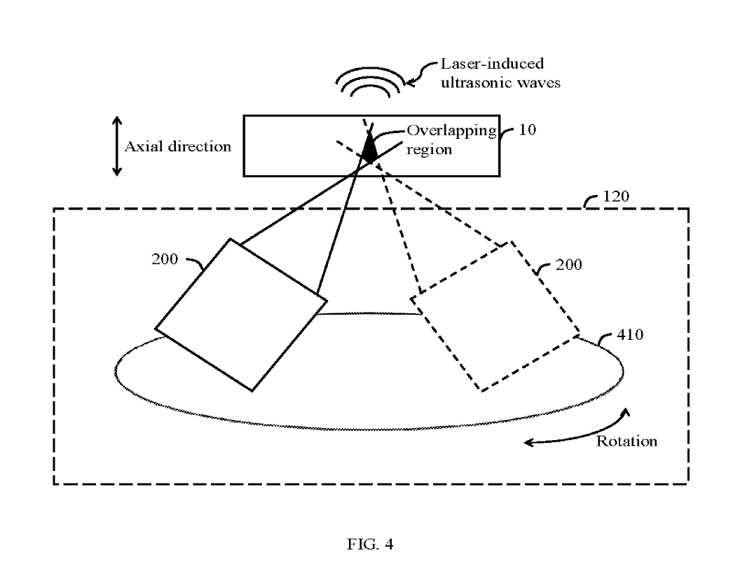

FIG. 4 shows a schematic diagram of the feedback-controlled laser 120 that includes the optical pickup head 200 and a rotator 410 upon which the optical pickup head 200 is mounted. The optical pickup head 200 and rotator 410 are aligned so that the optical paths of the laser beams generated by the optical pickup head 200 from different positions on the rotator 410 can overlap on an overlapping region. Because the overlapping region can be relatively small, the arrangement shown in FIG. 4 can increase the PAM system 100's resolution, especially along the axial direction indicated in FIG. 4.

With the feedback-controlled laser 120 shown in FIG. 4, the PAM system 100's PAM function can involve the following iterative steps. First, the rotator 410 positions (or repositions) the optical pickup head 200 to a first position. On the first position, the optical pickup head 200 emits a pulse of laser beam to a region of the object 10; the laser-induced ultrasonic waves coming out from the object 10 are detected by the ultrasonic transducer 140. Next, the rotator 410 rotates the optical pickup head 200 to a second position. On the second position, the optical pickup head 200 emits a pulse of laser beam to the region of the object 10; the laser-induced ultrasonic waves coming out from the object 10 are detected by the ultrasonic transducer 140. The PAM system 100 repeats these steps for a plurality of regions of the object 10, specifically, by relocating the overlapping region of the laser beams to the plurality of regions of the object 10 successively. Based on the resultant PAM imaging signal, the image generation unit 160 can generate PAM image(s) of the object 10 with an enhanced resolution.

For example, the PAM imaging signal may have a first time domain section corresponding to the laser-induced ultrasonic wave that comes out from a first region of the object 10 and is induced by a pulse generated by the optical pickup head 200 at one position. In addition, the PAM imaging single may have a second time domain section corresponding to the laser-induced ultrasonic wave that comes out from a second region of the object 10 and is induced by a pulse generated by the optical pickup head 200 at another position. The first and the second region of the object 10 may partially overlap with each other. By processing, combining, or reconstructing, the first and second time domain sections of the PAM imaging signal, the image generation unit 160 may enhance the axial resolution to the overlapping region on the object 10. Please note that the concept mentioned in this and the previous paragraphs can be expanded to an extent that for each region of the object 10, the optical pickup head 200 emitted N pulses of laser beam to the region from N different positions on the rotator 410, where N is an integer larger than two.

In addition to the components shown in FIG. 1, the feedback-controlled laser 120 can further include a micro-electromechanical lens set for each optical pickup head 200. The micro-electromechanical lens set can include a condenser lens, a set of mirrors, and an object lens. The micro-electromechanical lens set guides the laser beam from the optical pickup head 200 to the object 10 and the reflective light beam from the object 10 back to the optical pickup head 200. Furthermore, the micro-electromechanical lens set allows the laser beam to be focused on different regions of the object 10 by adjusting some internal component(s) of the micro-electromechanical lens set. As a result, the micro-electromechanical lens set allows the laser beam to be focused on different regions of the object 10 while the spatial relationship between the optical pickup head 200 and the object 10 remains unchanged. The inclusion of such a lens set can make it easier for the PAM system 100 to scan images of the object 10.

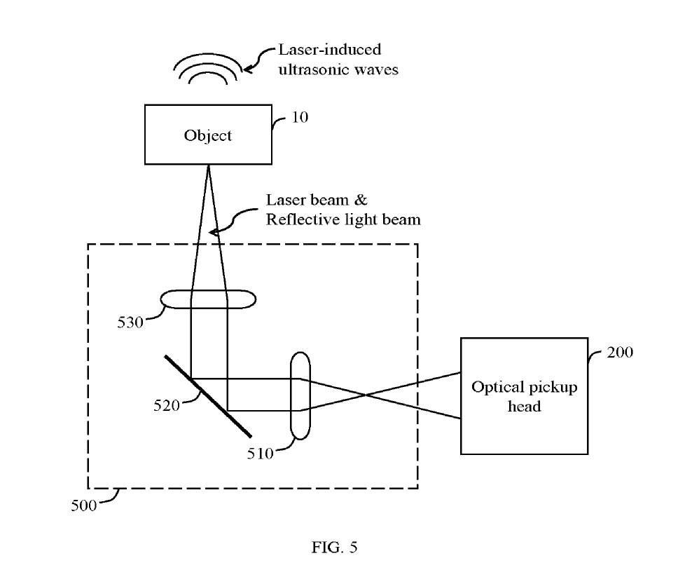

FIG. 5 shows a schematic diagram of an exemplary micro-electromechanical lens set. This micro-electromechanical lens set 500 includes a condenser lens 510, a mirror 520, and an object lens 530. By adjusting the angle and/or position of the mirror 520, the micro-electromechanical lens set 500 can optically sway the focus of the laser beam to different regions of the object 10.

In addition to functioning as a PAM, the PAM system 100 shown in FIG. 1 can further function as a scanning acoustic microscopy (SAM). To function as a SAM, the PAM system 100 must use the ultrasonic transducer 140 to emit and focus an ultrasonic pulse on a region of the object 10. Then, the ultrasonic transducer 140 detects sound-induced ultrasonic waves leaving the focused region of the ultrasonic pulse to generate a SAM imaging signal. The ultrasonic transducer 140 can include a single transducer unit to handle both the emission and detection of sound or two transducer units to handle the emission and detection of sound separately. By repeating the aforementioned process for a plurality of regions of the object 10, the image generation unit 160 can generate a SAM image (or multiple SAM images) of the object 10 based on the resultant SAM imaging signal. With proper scanning control, the PAM system 100 can provide both PAM image(s) and SAM image(s) of the object 10 within a single scan.

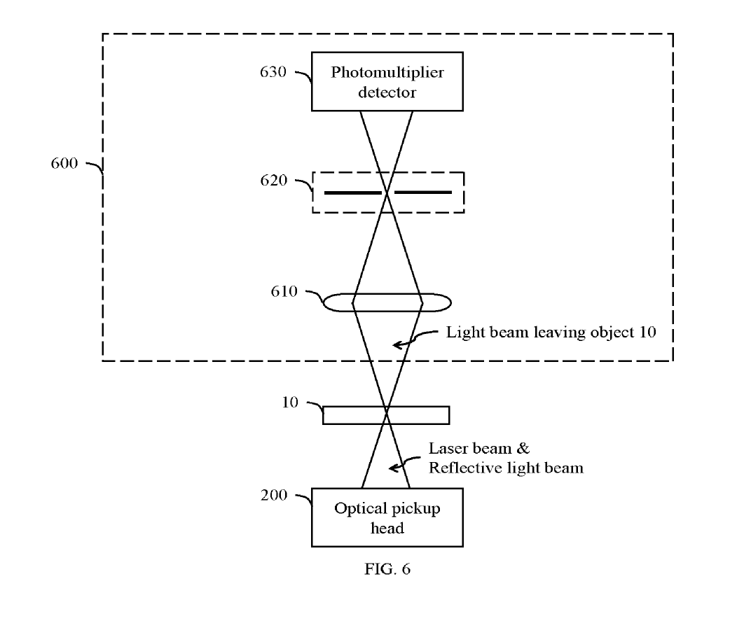

In addition to functioning as a PAM, the PAM system 100 shown in FIG. 1 can further function as a confocal microscopy (CM) by additionally including a CM component set 600 shown in FIG. 6. The CM component set 600 includes an object lens 610, a confocal pinhole 620, and a photomultiplier detector 630. The object lens 610 and the confocal pinhole 620 are arranged so that only the light coming out from the focus of the laser beam can reach the photomultiplier detector 630. The photomultiplier detector 630 can then generate a CM imaging signal based on the light detected, and send the CM imaging signal to the image generation unit 160. The image generation unit 160 then generates CM image(s) of the object 10 based on the CM imaging signal. With proper scanning control, the PAM system 100 can provide both PAM image(s) and CM image(s) of the object 10 within a single scan.

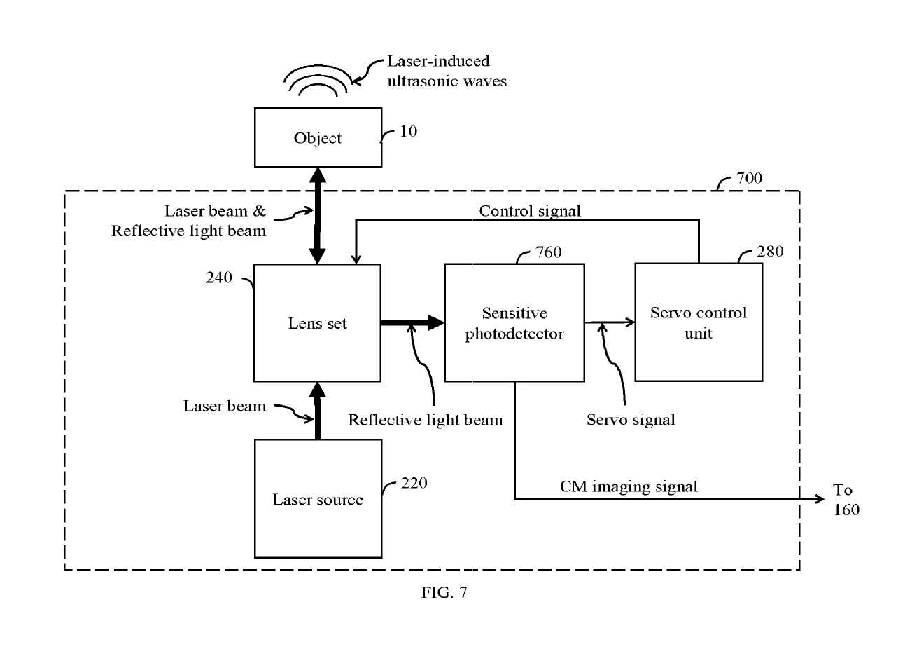

In another embodiment, the feedback-controlled laser 120 shown in FIG. 1 includes a modified optical pickup head 700 shown in FIG. 7. The modified optical pickup head 700 is different from the optical pickup head 200 shown in FIG. 2 in that the former has a sensitive photodetector 760 rather than the photodiode 260. For example, the sensitive photodetector 760 may be a photomultiplier tube (PMT) that is much more sensitive than the photodiode 260. Based on the light it detects, the sensitive photodetector 760 can generate not only a servo signal for the servo control unit 280 but also a CM imaging signal for the image generation unit 160. The image generation unit 160 then generates CM image(s) of the object 10 based on the CM imaging signal. With proper scanning control, the PAM system 100 can provide both PAM image(s) and CM image(s) of the object 10 within a single scan. The modified optical pickup head 700 can serve as the optical pickup head 200_1 of FIG. 3, the optical pickup head 200_2 of FIG. 3, the optical pickup head 200 of FIG. 4, the optical pickup head 200 of FIG. 5, the optical pickup head 200 of FIG. 6, or a combination thereof.

The PAM system 100 can also be configured to combine the concepts mentioned in the previous two paragraphs. The resulting PAM system can provide not only PAM image(s) but also SAM image(s) and CM image(s) of the object 10 within a single scan.

In the foregoing detailed description, the invention has been described with reference to specific exemplary embodiments thereof. It will be evident that various modifications may be made thereto without departing from the spirit and scope of the invention as set forth in the following claims. The detailed description and drawings are, accordingly, to be regarded in an illustrative sense rather than a restrictive sense.

What is claimed is:

1. A photoacoustic microscopy (PAM) system for observing an object, comprising:
an optical pickup head, configured to emit a laser beam to the object, generate a servo signal based on a reflective light beam received from the object, and position a focus of the laser beam onto the object based on the servo signal;
an ultrasonic transducer, configured to detect laser-induced ultrasonic waves leaving the object to generate a PAM imaging signal; and
an image generation unit coupled to the ultrasonic transducer, configured to generate a PAM image of the object based on the PAM imaging signal.

2. The PAM system of claim 1, wherein the optical pickup head comprises:
a laser source, configured to generate the laser beam;
a photodetector, configured to detect the reflective light beam and generate the servo signal accordingly;
a lens set, configured to direct the laser beam onto the object and direct the reflective light beam onto the photodetector; and
a servo control unit, coupled to the photodetector and the lens set, configured to control the lens set according to the servo signal.

3. The PAM system of claim 2, wherein the servo signal comprises a focus error (FE) signal.

4. The PAM system of claim 2, wherein the lens set provides a common optical path for the laser beam and the reflective light beam, and the laser beam and the reflective light beam passes through the optical path in two opposite directions.

5. The PAM system of claim 2, wherein the photodetector is further coupled to the image generation unit and configured to detect the reflective light beam and generate a confocal microscopy (CM) imaging signal accordingly, and the image generation unit is further configured to generate a CM image of the object based on the CM imaging signal.

6. The PAM system of claim 2, wherein the photodetector comprises a photomultiplier tube (PMT).

7. The PAM system of claim 1, wherein:
the ultrasonic transducer is further configured to emit an ultrasonic pulse to the object and detect sound-induced ultrasonic waves leaving the object to generate a scanning acoustic microscopy (SAM) imaging signal; and
the image generation unit is further configured to generate a SAM image of the object based on the SAM imaging signal.

8. The PAM system of claim 1, wherein:
the PAM system further comprises a confocal microscopy (CM) component set configured to detect light leaving the object from the focus of the laser beam to generate a CM imaging signal; and
the image generation unit is further coupled to the CM component set and configured to generate a CM image of the object based on the CM imaging signal.

9. The PAM system of claim 8, wherein the CM component set comprise:
a photomultiplier detector, configured to detect the light leaving the object from the focus of the laser beam to generate the CM imaging signal; and
an object lens and a confocal pinhole, configured to direct the light leaving the object from the focus of the laser beam onto the photomultiplier detector.

10. The PAM system of claim 1, further comprising a micro-electromechanical lens set configured to:
guide the laser beam from the optical pickup head to the object and the reflective light beam from the object to the optical pickup head; and
sway the focus of the laser beam to different regions of the object.

11. The PAM system of claim 1, wherein:
the PAM system further comprises another optical pickup head; and
the two optical pickup heads are aligned so that laser beams emitted by the two optical pickup heads share an overlapping region on the object.

12. The PAM system of claim 1, wherein:
the PAM system further comprises a rotator upon which the optical pickup head is mounted;
the rotator is configured to rotate the optical pickup head to a plurality of positions; and
the rotator and the optical pickup head are aligned so that laser beams emitted by the optical pickup head from the plurality of positions share an overlapping region on the object.

13. A method of observing an object, comprising:
using an optical pickup head to emit a laser beam to the object;
detecting laser-induced ultrasonic waves leaving the object to generate a photoacoustic microscopy (PAM) imaging signal; and
generating a PAM image of the object based on the PAM imaging signal.

14. The method of claim 13, further comprising:
using the optical pickup head to generate a servo signal based on a reflective light beam received from the object and to position a focus of the laser beam onto the object based on the servo signal.

15. The method of claim 14, wherein the servo signal comprises a focus error (FE) signal.

16. The method of claim 13, further comprising:
emitting an ultrasonic pulse to the object and detecting sound-induced ultrasonic waves leaving the object to generate a scanning acoustic microscopy (SAM) imaging signal; and
generating a SAM image of the object based on the SAM imaging signal.

17. The method of claim 13, further comprising:
detecting light leaving the object from a focus of the laser beam to generate a confocal microscopy (CM) imaging signal; and
generating a CM image of the object based on the CM imaging signal.

18. The method of claim 13, further comprising:
using a micro-electromechanical lens set to guide the laser beam from the optical pickup head to the object and a reflective light beam from the object to the optical pickup head; and
using the micro-electromechanical lens set to sway a focus of the laser beam to different regions of the object.

19. The method of claim 13, further comprising:
using the optical pickup head to emit a first pulse of laser beam to the object from a first position; and
using the optical pickup head to emit a second pulse of laser beam to the object from a second position;
wherein the first pulse of laser beam and the second pulse of laser beam share an overlapping region on the object.

20. The method of claim 13, further comprising:
using the optical pickup head to emit a first pulse of laser beam to the object; and
using another optical pickup head to emit a second pulse of laser beam to the object;
wherein the first pulse of laser beam and the second pulse of laser beam share an overlapping region on the object.
